(19) United States
(12) Patent Application Publication
(10) Pub. No.: US 2016/0299977 A1
(43) Pub. Date: Oct. 13, 2016

(54) Action-Based App Recommendation Engine

(71) Applicant: Quixey, Inc., Mountain View, CA (US)

(72) Inventor: Jason HREHA, Danville, CA (US)

(73) Assignee: QUIXEY, INC., Mountain View, CA (US)

(21) Appl. No.: 14/684,823

(22) Filed: Apr. 13, 2015

(51) Int. Cl. G06F 17/30; G06F 3/0484; G06F 3/0488; G06F 3/0482

(52) U.S. Cl. CPC G06F 17/30867; G06F 3/0482; G06F 3/04842; G06F 3/0488; G06F 17/30554; G06F 17/3053; G06F 17/30241; G06F 17/3087

(57) ABSTRACT

A system includes a first data store configured to store records, each corresponding to an application for a mobile device and including metadata identifying actions available to a mobile device user through use of the application. The identified actions are chosen from an ontology. A query module processes an application recommendation request that indicates a set of applications installed on the user device. A set generation module identifies a set of available actions associated with the user device applications and selects a set of unavailable actions mutually exclusive with the available actions. The set generation module determines a consideration set of applications, where each application implements at least one of the unavailable actions. A set processing module selects a chosen subset of applications from the consideration set. A results generation module responds to the request with an application recommendation response identifying each application in the chosen subset.

### FIELD

The present disclosure generally relates to recommendation systems and more particularly to automated recommendation systems for applications on computing devices.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In recent years, the use of Internet-connected devices such as smartphones and tablets has grown exponentially. The number and variety of available software applications for such devices has similarly grown by orders of magnitude. Presently, many diverse functions can be performed and many diverse sets of data can be analyzed on any given Internet-connected device. For example, app stores (referred to here as digital distribution platforms) such as the Google PLAY platform by Google, Inc., the APP STORE platform by Apple Inc., the Amazon APPSTORE platform by Amazon.com, Inc., the WINDOWS PHONE STORE platform and WINDOWS STORE platform from Microsoft Corp., and the GETJAR platform by GetJar, Inc., together offer millions of applications.

With such a wide array of available applications, many users of Internet-connected devices are not aware of the availability of applications that may perform actions of interest and/or provide data of interest to the users. Even app developers are unable to keep up to date on all of the applications that users might find valuable in segments of the application market where the app developer doesn't specialize.

### SUMMARY

A system includes a first data store configured to store records. Each of the records corresponds to an application for a mobile device and includes metadata identifying actions available to a mobile device user through use of the application. The identified actions are chosen from an ontology. The system includes a query module configured to process an application recommendation request corresponding to a user device. The application recommendation request includes data indicating a set of applications installed on the user device. The system includes a set generation module configured to identify, using the first data store, a set of available actions associated with the set of applications installed on the user device. The set generation module is configured to select a set of unavailable actions. The set of unavailable actions is mutually exclusive with the set of available actions. The set generation module is configured to determine a consideration set of applications from the first data store. Each application in the consideration set implements at least one of the set of unavailable actions. The system includes a set processing module configured to select a chosen subset of applications from the consideration set of applications. The system includes a results generation module configured to respond to the application recommendation request with an application recommendation response. The application recommendation response includes identifying data for each application in the chosen subset.

In other features, the first data store, for each of the records, includes data for an access mechanism for the application. The application recommendation response includes the access mechanism for each application in the chosen subset. In other features, for each of the records, the data for the access mechanism is a link to the application within a digital distribution platform. In other features, the set processing module is configured to determine a score for each of the applications in the consideration set and, as the chosen subset, select a predetermined number of applications from the consideration set of applications that have highest scores. In other features, the score for an application is based on reviews of the application and download statistics for the application.

In other features, the score for an application is inversely related to a total number of actions available to the user device through use of the application. In other features, the score for an application is directly related to a number of actions available to the user device through use of the application that are not within the set of available actions. In other features, the set processing module is configured to exclude, from the chosen subset, the set of applications installed on the user device. In other features, the set processing module is configured to exclude, from the chosen subset, applications that have been uninstalled from the user device. In other features, the set of available actions encompasses all actions within the ontology that are available to the user device through use of all of the set of applications installed on the user device.

In other features, the set of applications installed on the user device encompasses all applications installed on the user device. In other features, the application recommendation request is triggered in response to, for a first action of the ontology that corresponded to no records in the first data store, a new record being added to the first data store and corresponding to the first action. In other features, the first data store, for each of the records, includes data regarding geographical relevance of the record. The application recommendation request is triggered in response to the user device moving from a first geographical area to a second geographical area.

In other features, the system includes a monitor module configured to generate the application recommendation request in response to the metadata for a first record of the records being updated to add an additional action when the application corresponding to the first record had been uninstalled from the user device. In other features, the system includes a monitor module configured to generate the application recommendation request in response to the metadata for a first record of the records being updated to add an additional action when both (i) the application corresponding to the first record had been uninstalled from the user device and (ii) the additional action is outside the set of available actions.

In other features, for a first record of the first data store corresponding to an application from the set of applications installed on the user device, the application recommendation request is triggered in response to the metadata being updated to add an additional action. In other features, a first record of the first data store corresponds to multiple versions of a first application. The system includes a monitor module configured to generate the application recommendation request for the user device in response to a new version of the first application being added to the first record when both (i) the metadata for the new version includes an action from the ontology that is not included in previous versions of the first application and (ii) one of the previous versions of the first application is installed on the user device.

In other features, the monitor module delays the application recommendation request until the user device has failed to install the new version of the first application for more than a predetermined period of time. In other features, a first record of the first data store corresponds to a first version of a first application and the system includes a monitor module. The monitor module is configured to generate the application recommendation request for the user device in response to a second version of the first application being added to the first data store as a second record when both (i) the metadata for the second version includes an action from the ontology that is not included in the first version of the first application and (ii) the first version of the first application is installed on the user device.

In other features, the ontology is grouped into a hierarchical tree in which each of the actions is a leaf node. The set generation module is configured to identify parent nodes connected to multiple actions in the set of available actions and select remaining actions of the identified parent nodes as the set of unavailable actions. In other features, the ontology is grouped into a hierarchical tree in which each of the actions is a leaf node. The set processing module is configured to assign a score to each of the consideration set of applications, identify parent nodes connected to multiple actions in the set of available actions, increase the score for applications that implement remaining actions of the identified parent nodes, and select as the chosen subset the applications from the consideration set having highest scores.

In other features, the system includes a second data store configured to store records. Each of the records corresponds to a user device and stores data identifying applications that have been uninstalled from the user device. In other features, the system includes a second data store configured to store a user records. Each of the user records (i) corresponds to a user device and (ii) stores data identifying applications that have been identified as undesired by a user of the corresponding user device. The set processing module is configured to exclude applications from the chosen subset according to the second data store.

In other features, the system includes a second data store configured to store user records. Each of the user records (i) corresponds to a user device and (ii) stores data identifying actions that have been identified as undesired by a user of the corresponding user device. The set generation module is configured to remove actions from the set of unavailable actions according to the second data store. In other features, the set generation module is configured to selectively include, in the consideration set of applications, a first application that duplicates actions from the set of available actions.

In other features, the first application makes a first action of the ontology available to the user device. The set generation module is configured to include, in the consideration set of applications, the first application in response to usage data of the user device indicating a high usage of the first action.

In other features, the set generation module is configured to determine that the usage of the first action is high in response to the usage of the first action exceeding a predetermined threshold. The predetermined threshold is based on an average usage of the set of available actions. In other features, the application recommendation request is received directly from the user device. In other features, the application recommendation request is received from a search platform in response to the search platform receiving an application search request from the user device.

In other features, the application recommendation request includes data indicating that recommendations should be targeted to a scope of the application search request. In other features, the application recommendation response is independent of a scope of the application search request. In other features, each of the records includes additional metadata describing the corresponding application. The additional metadata includes a genre of the corresponding application. In other features, the additional metadata includes (i) user-provided review data for the corresponding application and (ii) download statistics for the corresponding application.

A method includes storing records into a first data store. Each of the records corresponds to an application for a mobile device and includes metadata identifying actions available to a mobile device user through use of the application. The identified actions are chosen from an ontology. The method includes processing an application recommendation request corresponding to a user device. The application recommendation request includes data indicating a set of applications installed on the user device. The method includes identifying, using the first data store, a set of available actions associated with the set of applications installed on the user device. The method includes selecting a set of unavailable actions. The set of unavailable actions is mutually exclusive with the set of available actions. The method includes determining a consideration set of applications from the first data store. Each application in the consideration set implements at least one of the set of unavailable actions. The method includes selecting a chosen subset of applications from the consideration set of applications. The method includes responding to the application recommendation request with an application recommendation response. The application recommendation response includes identifying data for each application in the chosen subset.

In other features, for each of the records, data for an access mechanism for the application is stored in the first data store. The application recommendation response includes the access mechanism for each application in the chosen subset. In other features, for each of the records, the data for the access mechanism is a link to the application within a digital distribution platform. In other features, the method includes determining a score for each of the applications in the consideration set and, as the chosen subset, selecting a predetermined number of applications from the consideration set of applications that have highest scores. In other features the score for an application is based on reviews of the application and download statistics for the application.

In other features, the score for an application is inversely related to a total number of actions available to the user device through use of the application. In other features, the score for an application is directly related to a number of actions available to the user device through use of the application that are not within the set of available actions. In other features, the method includes excluding, from the chosen subset, the set of applications installed on the user device. In other features, the method includes excluding, from the chosen subset, applications that have been uninstalled from the user device.

In other features, the set of available actions encompasses all actions within the ontology that are available to the user device through use of all of the set of applications installed on the user device. In other features, the set of applications installed on the user device encompasses all applications installed on the user device. In other features, the application recommendation request is triggered in response to, for a first action of the ontology that corresponded to no records in the first data store, a new record being added to the first data store and corresponding to the first action. In other features, for each of the records, data regarding geographical relevance of the record is stored in the first data store. The application recommendation request is triggered in response to the user device moving from a first geographical area to a second geographical area.

In other features, the method includes generating the application recommendation request in response to the metadata for a first record of the records being updated to add an additional action when the application corresponding to the first record had been uninstalled from the user device. In other features, the method includes generating the application recommendation request in response to the metadata for a first record of the records being updated to add an additional action when both (i) the application corresponding to the first record had been uninstalled from the user device and (ii) the additional action is outside the set of available actions.

In other features, for a first record of the first data store corresponding to an application from the set of applications installed on the user device, the application recommendation request is triggered in response to the metadata being updated to add an additional action. In other features, a first record of the first data store corresponds to multiple versions of a first application. The method includes generating the application recommendation request for the user device in response to a new version of the first application being added to the first record when both (i) the metadata for the new version includes an action from the ontology that is not included in previous versions of the first application and (ii) one of the previous versions of the first application is installed on the user device.

In other features, the method includes delaying the application recommendation request until the user device has failed to install the new version of the first application for more than a predetermined period of time. In other features, a first record of the first data store corresponds to a first version of a first application. The method includes generating the application recommendation request for the user device in response to a second version of the first application being added to the first data store as a second record when both (i) the metadata for the second version includes an action from the ontology that is not included in the first version of the first application and (ii) the first version of the first application is installed on the user device.

In other features, the ontology is grouped into a hierarchical tree in which each of the actions is a leaf node. The method includes identifying parent nodes connected to multiple actions in the set of available actions, and selecting remaining actions of the identified parent nodes as the set of unavailable actions. In other features, the ontology is grouped into a hierarchical tree in which each of the actions is a leaf node. The method includes assigning a score to each of the consideration set of applications, identifying parent nodes connected to multiple actions in the set of available actions, increasing the score for applications that implement remaining actions of the identified parent nodes, and selecting as the chosen subset the applications from the consideration set having highest scores. In other features, the method includes storing records into a second data store. Each of the records corresponds to a user device and stores data identifying applications that have been uninstalled from the user device.

In other features, the method includes storing user records into a second data store. Each of the user records (i) corresponds to a user device and (ii) stores data identifying applications that have been identified as undesired by a user of the corresponding user device. The method includes excluding applications from the chosen subset according to the second data store. In other features, the method includes storing user records into a second data store. Each of the user records (i) corresponds to a user device and (ii) stores data identifying actions that have been identified as undesired by a user of the corresponding user device. The method includes removing actions from the set of unavailable actions according to the second data store. In other features, the method includes selectively including, in the consideration set of applications, a first application that duplicates actions from the set of available actions.

In other features, the first application makes a first action of the ontology available to the user device. The method includes including, in the consideration set of applications, the first application in response to usage data of the user device indicating a high usage of the first action. In other features, the method includes determining that the usage of the first action is high in response to the usage of the first action exceeding a predetermined threshold. The predetermined threshold is based on an average usage of the set of available actions. In other features, the application recommendation request is received directly from the user device. In other features, the application recommendation request is received from a search platform in response to the search platform receiving an application search request from the user device.

In other features, the application recommendation request includes data indicating that recommendations should be targeted to a scope of the application search request. In other features, the application recommendation response is independent of a scope of the application search request. In other features, each of the records includes additional metadata describing the corresponding application. The additional metadata includes a genre of the corresponding application. In other features, the additional metadata includes (i) user-provided review data for the corresponding application and (ii) download statistics for the corresponding application.

In other features, the methods described above may be implemented by processor-executable instructions stored on a non-transitory computer-readable medium.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIGS. 1A and 1B are example graphical user interfaces that display apps recommended according to the principles of the present disclosure.

FIG. 2 is a graphical representation of a small subset of an example action ontology.

FIG. 3 is a high-level functional block diagram depicting how the principles of the present disclosure may be used in an application ecosystem.

FIG. 4A depicts example contents of a recommendation request.

FIG. 4B depicts example contents of a recommendation response.

FIG. 5 is a high-level functional block diagram of an example implementation of a recommendation system.

FIG. 6 is a high-level functional block diagram of another example implementation of a recommendation system.

FIG. 7A is a graphical representation of an example recommendation record format.

FIG. 7B is a graphical representation of another example recommendation record format.

FIG. 7C is a graphical representation of an example recommendation record according to the format of FIG. 7A.

FIG. 8 is a flowchart of high-level operation of the recommendation system.

FIG. 9A is a flowchart of example operation of the preparation and sending of a recommendation response.

FIG. 9B is a flowchart of another example operation of preparing and sending a recommendation response.

FIG. 10 is a high-level functional block diagram depicting one example of how the recommendation system can interoperate with an application search system.

FIG. 11 is a functional block diagram of an example implementation of a search system.

FIG. 12A is a graphical representation of an example application record format.

FIG. 12B is a graphical representation of an example application format record according to the format of FIG. 12A.

FIG. 13 is a flowchart of example interoperation between a search system and a recommendation system.

In the drawings, reference numbers may be reused to identify similar and/or identical elements.

### DETAILED DESCRIPTION

Prior recommendation systems simply recommend apps based on the overall popularity of the app within a certain genre or based on data from other users, such as those within one or two degrees of separation according to a social network. Meanwhile, the present disclosure identifies what actions may be performed by apps presently installed on the user device and recommends apps that can perform additional actions and/or improve the operation of the existing actions.

Applications can allow a user to perform a variety of different actions. For example, a restaurant reservation application can allow the user to make reservations at one or more restaurants. In another example, an Internet media player application can allow the user to stream digital media (such as a song or a movie) from the Internet. Often, a single application will allow the user to perform more than one action. For example, a restaurant reservation application may also allow a user to retrieve business information about a restaurant (such as hours of operation) and read reviews of the restaurant in addition to making reservations. As another example, an Internet media player application may also allow a user to search for and discover new music for streaming.

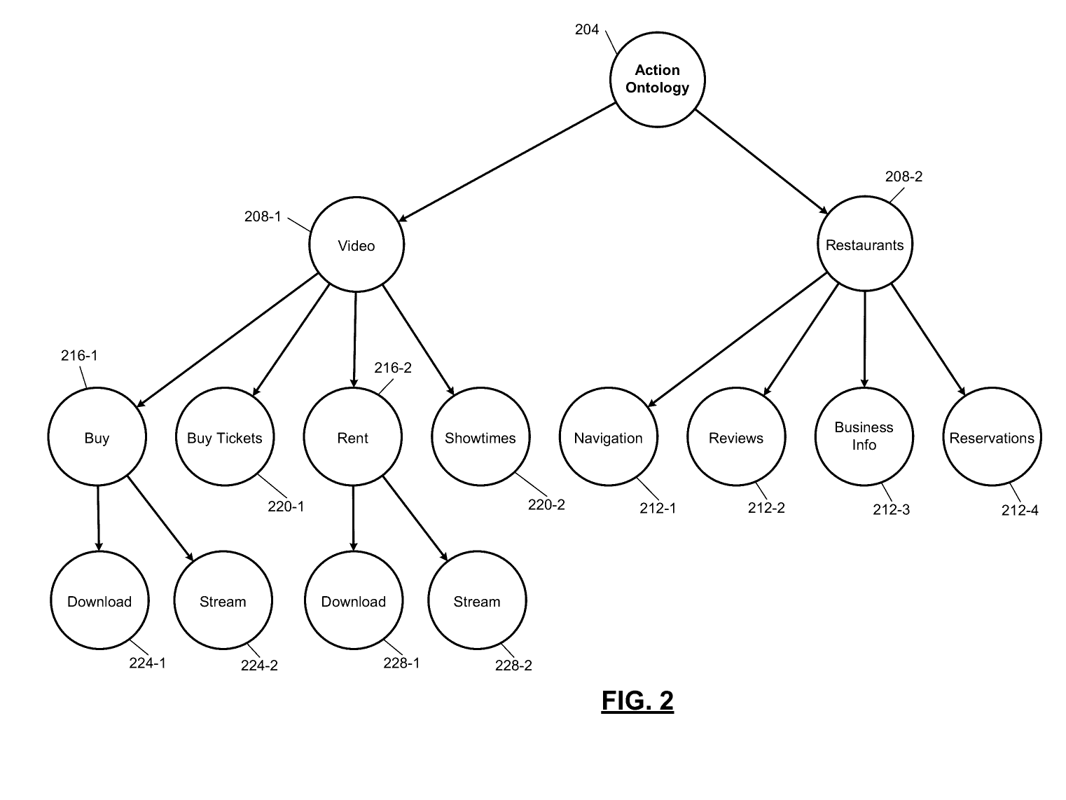

A recommendation system according to the present disclosure may be based around a defined action ontology. The ontology (an example of which is shown in FIG. 2) may define a hierarchical tree of actions. The functionality provided by an app can be described by selecting one or more actions from the action ontology. For example, the action “provide restaurant review” may be assigned to an app that includes reviews for restaurants. This restaurant review action may be grouped with other restaurant-related actions (such as making reservations and getting directions) within the action ontology. In another example of the action ontology, review-oriented actions may be grouped together. For example, a restaurant review action and a medical provider review action may be grouped together.

For another app, a “navigate” action may be assigned to the application because the application allows a user to navigate to a destination. The action ontology may be more or less granular in any specific area according to the design of the recommendation system. For example, “navigate” could be a single action or could describe a group of actions including “navigate by car,” “navigate by walking,” “navigate by bicycle,” and “navigate by public transport.”

As additional examples, actions may include finding transportation to a location (such as by ordering a car service or a taxi), ordering food from a restaurant, viewing food photos, viewing a restaurant menu, searching for a business, reading reviews of businesses, looking up food recipes, exchanging text communications, checking stocks, checking the weather, checking sports scores, playing music, playing films, listening to radio stations, recording video, and identifying discounts on goods or services.

The recommendation system developer (or other organization or person) can assign actions to applications manually upon reviewing and/or using the application. The developer may contract with one or more reviewers to identify actions for some or all applications available in a digital distribution platform.

To control costs, in various implementations actions are manually assigned only to applications that meet certain threshold criteria. For example, the action content of an application may be reviewed once the application has more than a threshold number of total downloads or have a download rate (such as downloads per month) that exceeds a different threshold. When an app developer already has one application that meets these criteria, other applications from that developer may also be analyzed by the reviewers.

A machine learning algorithm may analyze apps and infer actions that the app can perform. For example, an app that includes a variety of states that are each specific to names that the machine learning algorithm recognizes as restaurant names may be a restaurant app. The machine learning algorithm may further analyze user interface elements of the app to determine what actions can be taken with respect to each restaurant.

The machine learning algorithm may be used to identify a preliminary set of actions, which are then verified by a human reviewer. In addition, social feedback may be used to correct inferences from the machine learning algorithm. For example, user feedback may be solicited regarding whether an app provides for a certain action to be performed. Over time, the user feedback may provide an accurate indication of whether that action can actually be performed using the app. If user feedback overwhelmingly suggests the action cannot be performed, the machine learning algorithm may remove the action from the list of identified actions for that app.

Based on the actions corresponding to applications installed on a user's device, the recommendation system can make recommendations of additional apps to the user. For example, the recommendation system can recommend apps to a user that provide actions that are not otherwise available from the apps already installed on the user's device.

The recommendation system can also identify actions that are already provided by one or more apps installed on the user's device but that are better performed by a different app. The recommendation system can also recommend applications that provide newly available actions that were previously unknown to the recommendation system. For example, when a new action is added to the action ontology because an app provides an action that was previously unknown, the recommendation system may recommend that app because it provides an action that apps had previously not performed.

The recommendation system can also encourage a user to update an app to access additional functionality and may recommend that a user reinstall a previously uninstalled app because a new version of that app provides an additional function. In some instances, the lack of a function may have led to uninstallation of the app and the introduction of that action will make the app newly relevant to the user.

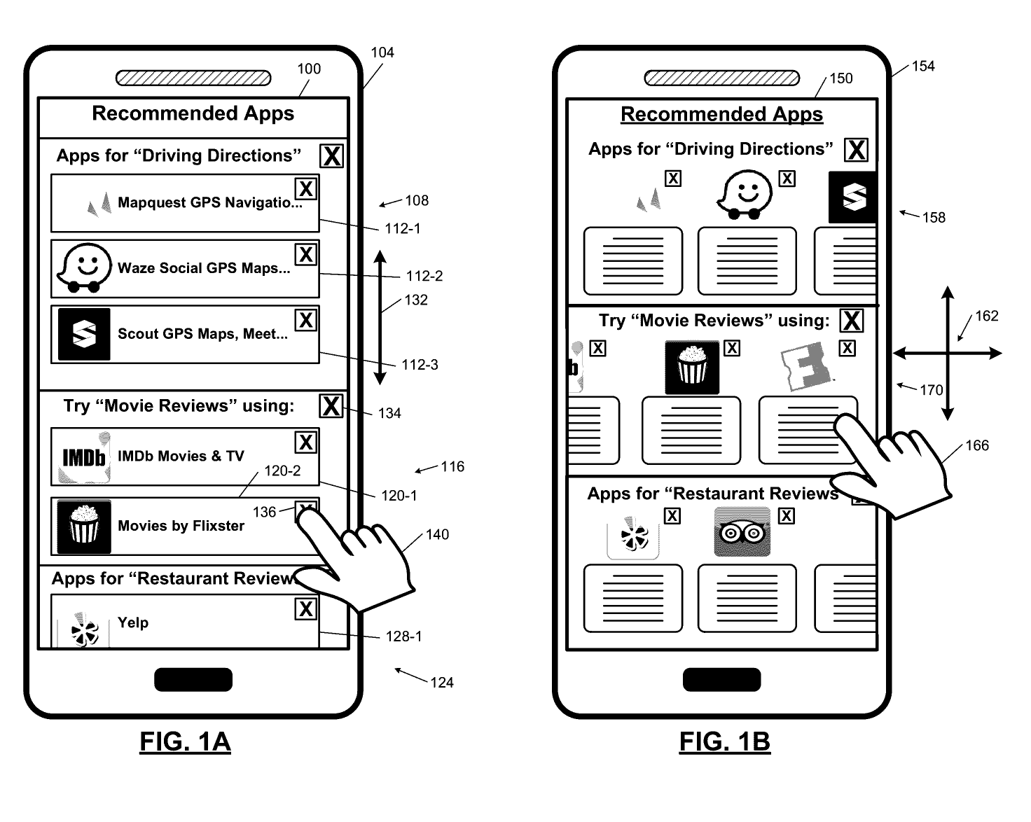

In FIG. 1A, a simple user interface shows a recommended apps display 100 in a user device, such as a smartphone 104. The recommended apps display 100 may be part of a stand-alone app for offering recommendations. In other implementations, the recommended apps display 100 may be displayed as a feature of another app.

In various implementations, a system-level or launcher-level software program may display the recommended apps display 100 at various times. For example, the recommended apps display 100 may be shown in response to a push notification from a recommendation system. Further, in various locations of the operating system interface, such as an app listing, there may be an icon, button, or textual link that can be selected to find additional apps. Corresponding text may be, for example, “Find more apps,” “Get more apps,” or “Recommended apps.” Selecting the user interface element may lead to the recommended apps display 100 being shown. For some operating systems and for some feature sets of the recommendation system, root level access may be used.

Recommendations may alternatively or additionally be provided to a user through out-of-band communication, such as with email, text messages, TWITTER messaging platform messages, etc. Device-based notifications (such as in a notification bar, notification tray, status bar, etc.) or even temporary popup messages (sometimes referred to as toasts) may be displayed to indicate the availability of recommended apps or to recommend specific apps.

Apps (actually, icons corresponding to the apps) may be organized into folders by category. For example, one folder may be related to music listening, while another is related to transportation. Relevant recommended apps may be displayed according to the category of a folder. For example, recommended transportation apps may be displayed when the user is viewing a transportation folder. The availability of recommended apps in the folder may be indicated by text or an icon, such as a plus sign. Selecting the indication may bring up a list of recommended apps.

In addition, the availability of recommended apps may be indicated by text or an icon wherever a full list of installed apps is displayed (such as by a launcher program or operating system). Further, either in the full app list, or in other locations, such as on a home screen or within a folder, icons for recommended apps may be shown. The fact that the app is recommended and not actually installed may be indicated graphically, such as by ghosting (increasing transparency and/or converting to greyscale) the icon.

Recommended apps may also be shown in digital distribution platform apps, such as the app for accessing the GOGGLE PLAY distribution platform. For example, a tab with device-specific recommendations may be added. Alternatively, searching and browsing for apps within the digital distribution platform may cause recommended apps to be shown, and the recommendations may be tailored to the area of the distribution platform that the user is browsing or searching.

For any individual installed app, recommended apps may be identified. The recommended apps may perform more or different actions than an installed app, or perhaps may perform one of the actions better. The availability of recommended apps for an installed app may be indicated by a visual cue either within the installed app or associated with an icon or widget used to access the app, such as from a launcher or home screen. For example, a small graphic such as a jewel may be overlaid on part of the icon to indicate that recommended apps are available. Accessing the recommended apps may be accomplished by pressing and holding on the icon or by touching the jewel.

In the first portion of the recommended apps display 100, apps for an action called “driving directions” are displayed. For example, recommended apps are displayed at 112-1, 112-2, and 112-3. The recommended apps 112 may be shown with corresponding text as well as an icon. A second portion 116 of the recommended apps display 100 suggests trying alternative applications for an action called “movie review” that may already be available from an installed app. At 120-1 and 120-2, example movie review apps are shown. A third portion 124 of the recommended apps display 100 includes a recommended app 128-1 for an action called “restaurant reviews.”

As indicated at arrow 132, vertical scrolling may permit the user to see additional apps, such as additional recommended apps for restaurant reviews. Each action may be associated with a user interface element such as an “X” 134 to indicate the user is not interested in receiving recommendations related to that action. In addition, user interface elements such as an “X” 136 may indicate that the user is not interested in a particular app. A hand is graphically depicted at 140 (miniaturized compared to an average human hand to avoid obstructing more of the figure). The position of the hand 140 demonstrates selection of the user interface element 136 (such as by a finger tap) to indicate that the app “Movies by Flixster” is not of interest to the user.

In FIG. 1B, a recommended apps display 150 is shown in a user device, such as a smartphone 154. Recommended apps for “driving directions” are shown in a first portion 158. Each app may include an icon as well as text. The text may include title of the application, reviews of the application, description of the application, etc.

As indicated by intersecting arrows 162, vertical as well as horizontal scrolling may allow for additional actions to be displayed as well as for additional recommended apps to be shown for a given action. For example, a miniaturized hand 166 may indicate that a second portion 170 of the recommended apps display 150 has been swiped to the left. As a result, a left-most app (IMDb Movies & TV) is partially obscured while a right-most app (Fandango) is now fully shown. Again, user interface elements may allow a user to indicate a disinterest in a particular action or a particular app.

Selecting one of the apps (such as by clicking or tapping on any portion of an app that is not the X user interface element) in either FIG. 1A or FIG. 1B may lead to additional information about that app or may directly lead to an access mechanism for that app. For example, the access mechanism may be a direct link to that app within a digital distribution platform.

In FIG. 2, an example action ontology has a root node 204 and two sample branch nodes: video 208-1 and restaurants 208-2. The restaurants branch node 208-2 is the parent node for leaf nodes navigation 212-1, reviews 212-2, business info 212-3, and reservations 212-4.

The video branch node 208-1 may be a parent node for a buy video branch node 216-1 and a rent video branch node 216-2. As shown in FIG. 2, leaf nodes of the action ontology may be at different depths (number of hops from the root node 204). For example, the video branch node 208-1 may be the parent node for buy tickets 220-1 and showtimes 220-2. Meanwhile, the buy video branch node 216-1 may be a parent node to the download action 224-1 and a stream action 224-2. Similarly, the rent branch node 216-2 may include leaf nodes 228-1 and 228-2 for download and stream, respectively.

As mentioned above, an action ontology can be defined in a number of ways. For example only, the download nodes 224-1 and 228-1 may instead be combined as a “download” branch node with buy download and rent download leaf nodes. Similarly, the stream nodes 224-2 and 228-2 may instead be a common branch node with buy streaming and rent streaming as leaf nodes.

Further, the level of granularity may change depending on the needs of the recommendation system. For example, the recommendation system may not need to draw a distinction between downloading and streaming for video rental at 216-2 and may therefore make the rental node 216-2 a leaf node and eliminate the nodes 228-1 and 228-2. For example, this may be done when every app that allows a user to download a rental also allows the user to stream a rental. This merging may also be done when the number of apps allowing a user to perform a rental is so small that subdivision is not necessary.

Each action that an app can perform may be accessible from one or more states of the app. A state may refer to a screen of an app, such as the home screen or a screen dedicated to restaurant reviews of a particular restaurant. States of an app may be associated with URLs (Uniform Resource Locators). URLs for an app may follow certain patterns, with each pattern corresponding to a different action. Therefore, the number of different URL patterns may indicate a lower limit on the number of different actions supported by the app, and the collection of URL patterns may translate to a collection of supported actions.

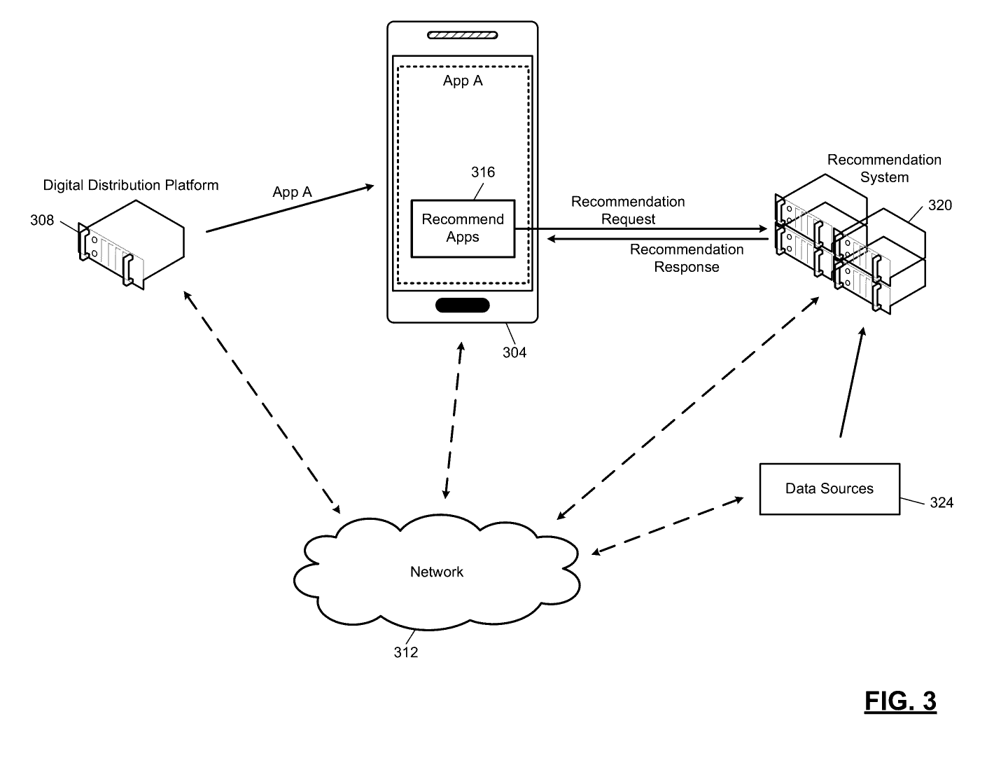

In FIG. 3, a high-level overview of the overall system is shown. A user device 304 connects to a digital distribution platform 308 via a network 312, such as the Internet. The user device 304 receives an application (referred to as “App A” in FIG. 3) from the digital distribution platform 308. When executed by the user device 304, App A may present a user interface element 316, such as a recommended apps button.

When the user interface element 316 is actuated, a recommendation request is sent to a recommendation system 320. The recommendation system 320 responds to the user device 304 with a recommendation response. The recommendation response may lead to a display, such as that shown in FIG. 1A or 1B.

Data sources 324 may provide source data for use by the recommendation system 320. The data sources 324 may include data from application developers, such as the websites of application developers and data feeds provided by developers. Data sources 324 may include digital distribution platforms such as the digital distribution platform 308. The data sources 324 may also include other websites such as blogs, application review websites, and social networking sites. The data sources 324 may include online databases of data related to movies, television programs, music, restaurants, locations, etc.

Each of the data sources 324 may have independent data structures and may be updated at different rates. Therefore, the recommendation system 320 may be updated from the data structure 324 at different rates. In addition, credibility and accuracy of data may differ across the data sources 324, which may be used to weight data differently depending on which of the data sources 324 provided the data.

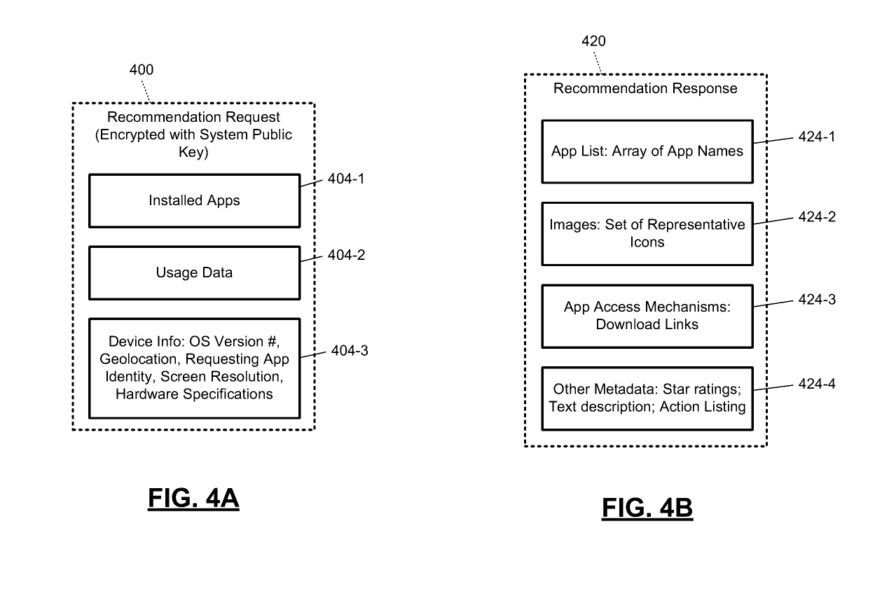

In FIG. 4A, an example recommendation request 404 is shown. The recommendation request 404 may be encrypted with a public key of the recommendation system. This will allow the recommendation system, but no one not in possession of the private key, to decrypt the recommendation request 404.

The recommendation request 404 may include a listing of installed apps 404-1. The installed apps 404-1 may include an exhaustive list of all installed applications or may include a reduced representation approximating the installed applications. For example only, a Bloom filter representation may be used. The Bloom filter specifies whether an app from a predefined set of apps is possibly installed on the device or is definitely not installed. In other words, to achieve compression, the output of a Bloom filter does not definitively state that a certain app is present; the Bloom filter output only definitively states whether a certain app is not present.

Usage data 404-2 indicates usage of the installed apps. For example, a behavior monitor on the user device may be a standalone application or may be incorporated in to the operating system, a search application, a web browser, and/or other native applications. The behavior monitor can monitor the use of the user device to collect usage data. For example, the behavior monitor may execute as a background process.

For example, the behavior monitor may record each time an app is invoked and how long a user spends engaged with the app before switching to another app. The behavior monitor may also determine which states of an app the user spends time with. Each application state may correspond to a certain action. Therefore, the behavior monitor may be able to discriminate which actions a user is interested in when using a particular app.

The behavior monitor may store this usage data and provide it as part of the recommendation request 404. For example only, statistical data provided as part of the usage data 404-2 may include a frequency (such as number of times per month) that an application is used and a percentage of time that the user spends in an application compared to on the user device as a whole. The usage data 404-2 may therefore be used to identify which actions and application are of most interest to a user.

The recommendation request 404 may include device info 404-3, which may include the operating system and the operating system version number for the device, geolocation data for the device, an identity of the app that generated the recommendation request 404, an identity of the app developer of that app, the screen resolution of the device, the orientation of the device (portrait or landscape), sensor capability (such as position of accelerometer or presence of heart rate sensor), etc. The device info 404-3 may be used to prevent apps from being recommended that will be incompatible or suboptimal with a screen resolution or operating system version of the user device.

At FIG. 4B, an example recommendation response 420 includes an app list 424-1. For example, the app list 424-1 may include an array of strings, each string storing an app name. The order of the array may be from most relevant to least relevant. The number of apps provided in the app list 424-1 may be chosen according to the resolution of the user device. For example, a device with a larger screen and/or higher resolution may receive a larger number of apps.

An images field 424-2 may include encoded images for each of the apps in the app list 424-1. The images may be displayed next to app names to visually identify the apps. App access mechanisms 424-3 may include links to a digital distribution platform to download apps for installation. In various implementations, recommended apps may be web-based and run within a browser on the user device. Access mechanisms for such apps may include a URL to be opened by a browser.

Additional metadata 424-4 may include a star rating for each app, a text description for each app, review text and metrics (such as number of reviews), and a listing of actions enabled by each app. The listing of actions may include all actions enabled by each app, or only a listing of actions enabled by each app that were not provided by apps already installed on the user device. In other implementations, the action listing may list the actions for which each app is best suited.

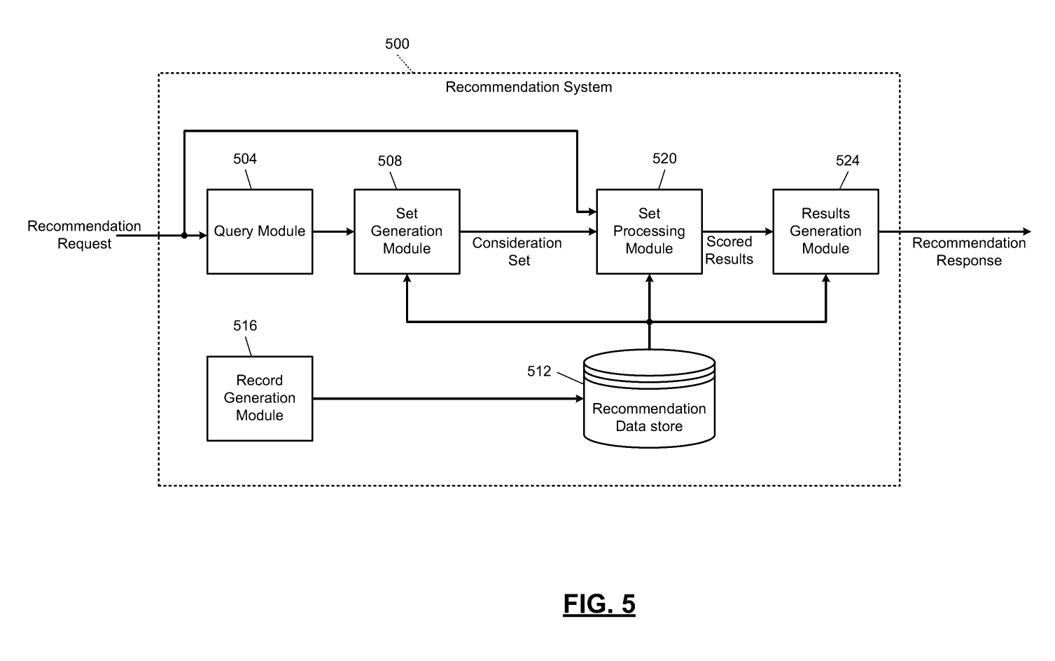

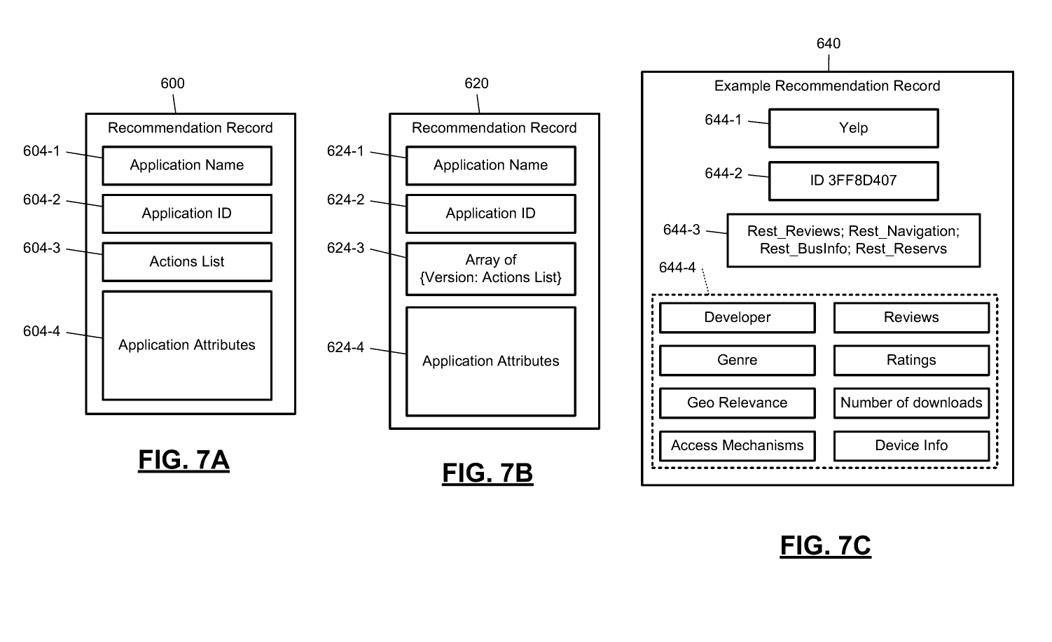

In FIG. 5, a block diagram of an example implementation of a recommendation system 500 includes a query module 504 that receives the recommendation request and provides data from the recommendation request to a set generation module 508. The set generation module 508 identifies a consideration set of recommendation records from a recommendation data store 512. The recommendation data store 512 includes records such as those described in FIGS. 7A-7C.

A record generation module 516 produces the records, including tagging apps with the actions enabled by those apps. The record generation module 516 may allow manual assignment of actions to apps to create records in the recommendation data store 572. In addition, the record generation module 516 may implement a machine learning algorithm as described above, to automatically tag apps with corresponding actions. The record generation module 516 may also allow a developer of the recommendation system 500 to update the specified action ontology.

The consideration set of apps is processed by a set processing module 520. The set processing module 520 may score each record of the consideration set, where the score may be based on elements of the recommendation request. The highest scored search results along with their corresponding scores are provided to a results generation module 524.

Scoring may also be referred to as ranking and may involve filtering (removing an app from the consideration set, which may be accomplished by setting the score to a minimum value such as zero). The scoring may be based on app popularity (number of downloads, average rating, number of downloads in the previous month), how recent the present version of the app is, and an app quality score (which may be based on how frequently an app is updated, and whether average user reviews increase or decrease with each new version).

The scoring may also be based on how the actions provided by apps in the consideration set match up with actions already available on the user device. For example, when multiple leaf nodes under the same parent node in the action ontology are already available on the user device, the set processing module 520 may assign higher scores to those apps that provide the remaining actions under the same parent node. Using FIG. 2 as an example, if the apps installed on the user device allow for actions 212-2 (restaurant reviews) and 212-3 (business info), then the other actions under the parent node 208-1 (restaurants) may contribute to a higher score. That is, apps that allow restaurant navigation 212-1 and/or restaurant reservations 212-4 may receive a higher score.

The set processing module 520 may filter out apps that are already installed on the user device as indicated by the recommendation request. Further, the set processing module 520 may filter out apps that are incompatible with attributes such as operating system version and resolution as specified in the recommendation request. Further, the set processing module 520 may filter out or alter the ranking of apps based on their geographical relevance to the geolocation of the user device.

The results generation module 524 prepares a recommendation response including the top scored results, where the data associated with each result may include text, an icon, and one or more access mechanisms. The results generation module 524 sends the prepared recommendation response to the sender of the recommendation request.

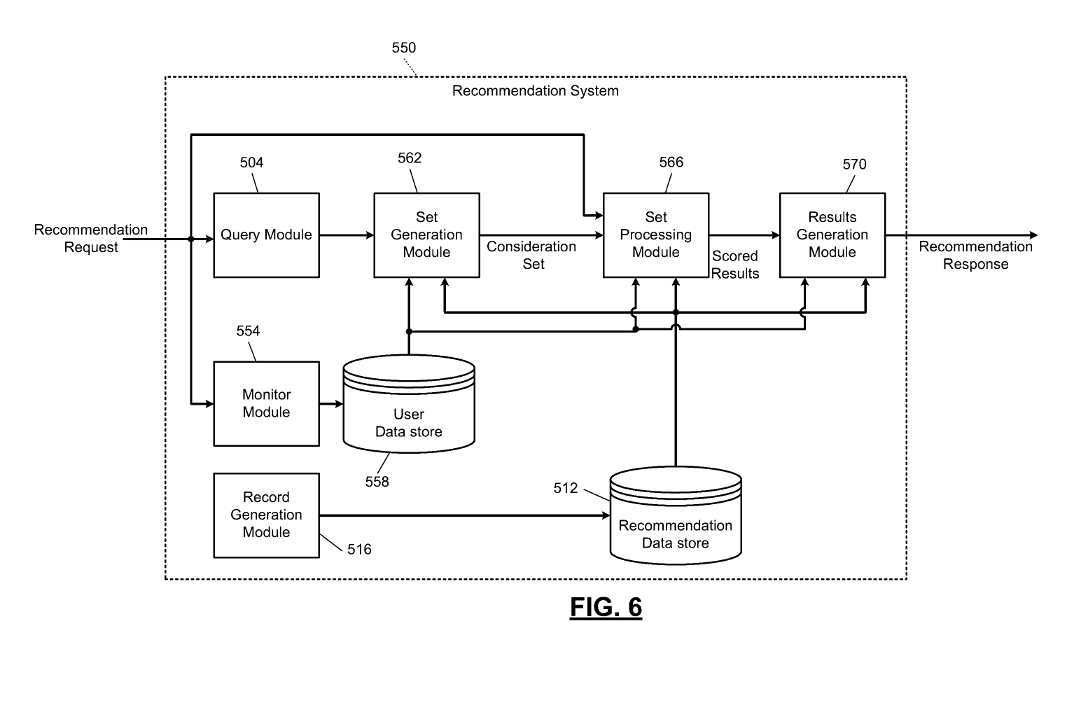

In FIG. 6, another example implementation of a recommendation system 550 includes a monitor module 554 that creates records in a user data store 558. The monitor module 554 may record, into the user data store 558, feedback from a user device, including usage data of apps and actions within the user device. The monitor module 554 may also track which applications are installed on the user device in the user data store 558 and may therefore be able to determine when an app has been uninstalled from the user device.

The set generation module 562, the set processing module 566, and the results generation module 570 may function similarly to the set generation module 508, the set processing module 520, and the results generation module 524 of FIG. 5. The set generation module 562 may take into account whether the user has indicated that certain actions and/or apps are of less interest. These apps may be filtered out from the consideration set; further, apps that only perform actions that are not of interest to the user may also be filtered out from the consideration set.

The set processing module 566 may assign a higher score to results that do not perform any actions deprecated by the user. The set processing module 566 may also elevate the score of apps that perform actions where usage data indicates the user performs those actions more frequently. The results generation module 570 may order results differently depending on whether a user has previously indicated a lack of interest in either an app or an action.

For example, after a first instance of a user indicating disinterest in an action, the results generation module 570 may apply a certain amount of transparency to recommended apps with that action. After a second indication of disinterest from the user, recommended results corresponding to that action may be removed all together. A single instance of user indication of disinterest may generally not be interpreted as a complete and permanent disinterest in an action. Instead, the user may have indicated a disinterest simply at that moment in time or may have inadvertently actuated the user interface element related to disinterest. Therefore, the results generation module 570 may visually indicate that the user's previous choice has been acknowledged without foreclosing the possibility of presenting a valuable recommendation to the user.

In FIG. 7A, an example format of the recommendation record 600 includes an application name 604-1, an application identifier (ID) 604-2, an actions list 604-3, and application attributes 604-4. The recommendation record 600 generally represents data that can be stored in the recommendation data store 512 for a specific application. The recommendation data store 512 may include thousands or millions of records having the structure specified by FIG. 7A.

The application ID 604-2 uniquely identifies an application within the recommendation data store 512. In various implementations, the application ID 604-2 may be the same across all versions of an application and across all editions of that application. In this sense, edition refers to versions of the app for different operating systems (such as Apple Inc.'s IOS operating system and Google Inc.'s ANDROID operating system) as well as a web-based edition of the app.

The application ID may be assigned by the recommendation system itself and may be independent of any ID assigned by, for example, a digital distribution platform. The actions list 604-3 indicates actions from the action ontology that can be performed by the application. In various implementations, a separate recommendation record may be present for each version and for each edition of an application. In this way, the actions list 604-3 may be specific to the specified edition and version of the app.

The application attributes 604-4 may include any type of data that can be associated with the app specified by the application ID 604-2. For example, the application attributes 604-4 may include the name of the developer of the application, the publisher of the application, the category (also known as genre) of the application, a textual description of the application (which may be received from the developer), a version number of the application, the operating system requirements for the application, and the price of the application.

The application attributes 604-4 may also include security and privacy data about the application, battery usage of the application, and bandwidth usage of the application. The application attributes 604-4 may also include application statistics such as total number of downloads, downloads per month, total number of numeric ratings, total number of text reviews, numbers of ratings and reviews for the latest version of the app, etc. The application attributes 604-4 may also include digital media related to the app such as icons and screen shots.

The application attributes 604-4 may include geographical relevance of the app. For example, the geographical relevance may specify a geographic area in which the app is most relevant. The application attributes 604-4 may specify a tiered system of relevance, with one geographic area indicating where the app is of highest relevance, a second geographical area where the app is of slightly lesser relevance, and a third geographical area where the app is of some relevance. The app may have little or no relevance outside of these areas.

The geographical areas may be specified in a variety of ways, such as by GPS coordinates, ZIP codes, cell phone tower coverage areas, Wi-Fi access point coverage areas, etc. For example only, a geographical area may be specified by a center point and a radius or by edges that define a polygon. In various implementations, a geographical area may include two or more discontiguous regions.

In FIG. 7B, another example format for an application record 620 includes application name 624-1, application ID 624-2, an array of action lists 624-3, and application attributes 624-4. When the recommendation record 620 applies to multiple versions of an app (which may also encompass multiple editions of the app), the array 624-3 may include a separate actions list for each version of the app. Although an array data structure is specified, other data structures, which may be more storage efficient, can also be used.

In FIG. 7C, an example recommendation record 640 for an application named “Yelp” 644-1 has a fictional ID of 3FF8D407 644-2. An actions list 644-3 indicates that the YELP application can perform actions from the action ontology named restaurant review (rest_reviews), restaurant navigation directions (rest_navigation), restaurant business info (rest_businfo), and restaurant reservations (rest_reservs). Although the actions are displayed in this example using human-readable abbreviations, the actual recommendation records may include hexadecimal or bit field representations that more compactly describe the nodes of the action ontology that apply to the app. Examples of application attributes are displayed at 644-4 and include developer, reviews, ratings, genre, number of downloads, geographical relevance, device info, and access mechanisms for the app.

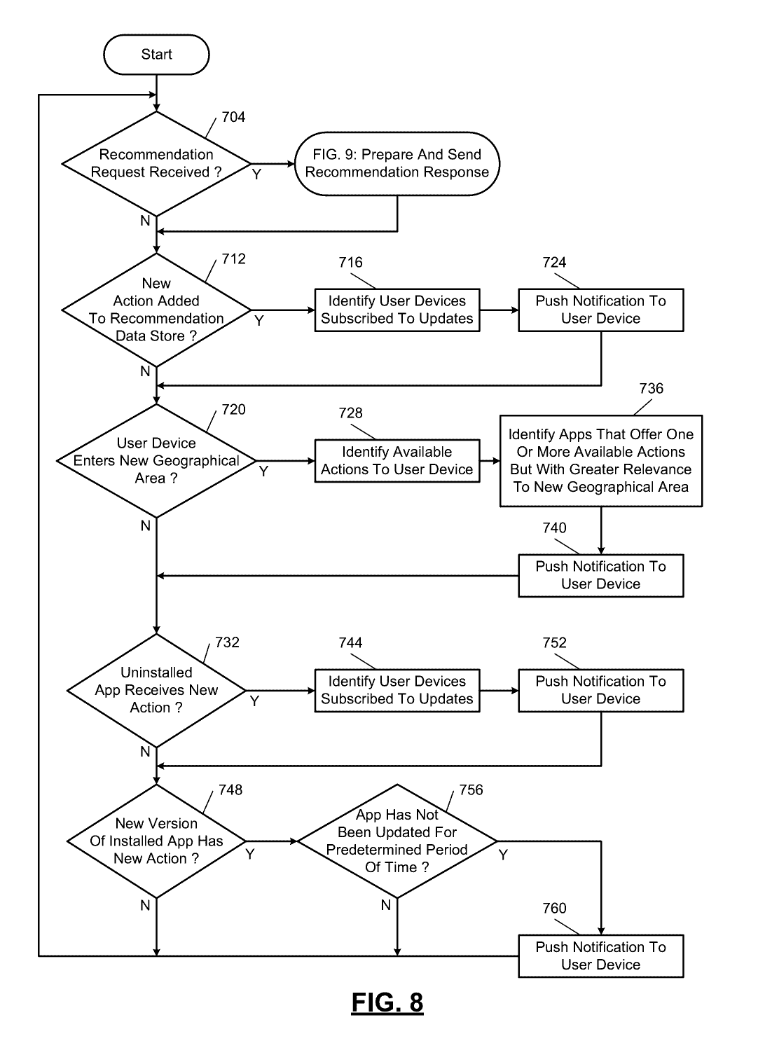

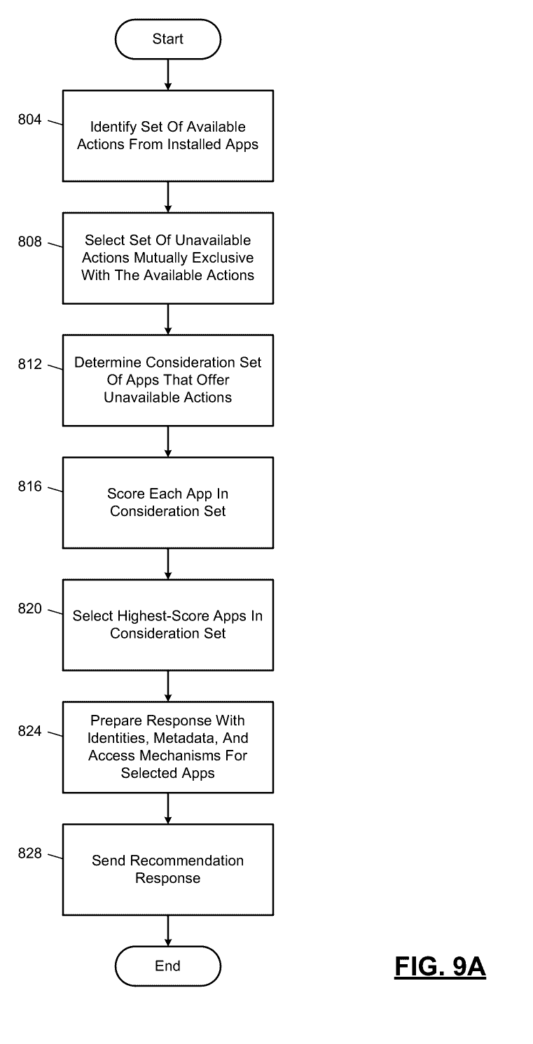

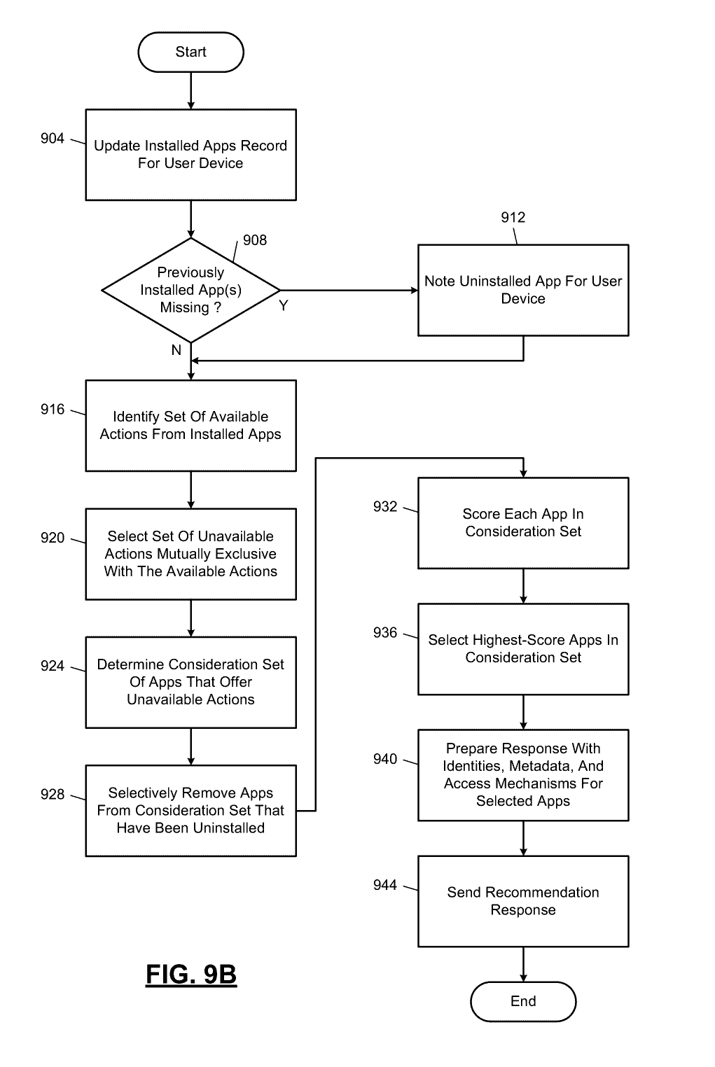

In FIG. 8, a flowchart encompasses a variety of facets of a recommendation system according to the present disclosure. Control begins at 704, where if a recommendation request is received, control transfers to 708; otherwise, control transfers to 712. At 708, control prepares and sends a recommendation response to the recommendation request. This may be performed according to either FIG. 9A or FIG. 9B. Control then continues at 712.

At 712, control determines whether a new action has been added to the recommendation data store. If so, control transfers to 716; otherwise, control transfers to 720. At 716, a new action that was not previously available is now available. This may mean that a leaf node of the action ontology previously was not mapped to any application. In other situations, the action may have been added to the action ontology specifically for this application's new functionality.

At 716, control identifies user devices that are subscribed to updates about new actions. User devices may automatically be subscribed upon accessing the recommendation system. A user of the user device can simply unsubscribe from any recommendations that are not of interest or may unsubscribe altogether from recommendation system updates. At 724, control pushes notifications to user devices that have subscribed to the updates. These push notifications may be by way of an app or background process on the user device or may use other distribution mechanisms, such as email or TWITTER messaging platform messages. Control then continues at 720.

At 720, control determines whether a user device has entered a new geographical area. If so, control transfers to 728; otherwise, control transfers to 732. At 728, control identifies actions that are available to the user device from installed applications and continues at 736. At 736, control identifies apps that offer one or more of the available actions though with greater relevance to the new geographical area. At 740, control pushes notifications to the user device based on apps that have greater geographical relevance. Control then continues at 732.

At 732, control determines whether an app that has previously been uninstalled from the user device has newly-added functionality. If so, control transfers to 744; otherwise, control transfers to 748. At 744, control identifies user devices subscribed to updates and at 752, control pushes notifications to those user devices. As discussed above, the notifications can take many forms. Once the notifications are pushed out to the user devices, control transfers to 748.

At 748, if a new version of an installed app has new functionality, control transfers to 756; otherwise, control returns to 704. At 756, control determines whether the installed app that is the subject of the new action has not been updated on a user device for at least a predetermined period of time. If the app has not been updated within this period of time, control transfers to 760; otherwise, control returns to 704. At 760, control pushes the notification of the app update to the user device to encourage the user to update the app to receive the additional functionality. Control then returns to 704.

In FIG. 9A, example operation of preparing and sending a recommendation response, which may have been called for by FIG. 8, is shown. Control begins at 804, where a set of available actions is identified from the apps installed on the user device. At 808, control selects a set of unavailable actions that are mutually exclusive with the available actions. In some implementations, the unavailable actions may be all other actions that are not available from the installed apps.

At 812, control determines a consideration set of apps where each app offers at least one of the unavailable actions. At 816, a score is assigned to each app within the consideration set. At 820, control selects the highest scored apps in the consideration set. At 824, control prepares a response based on the selected apps and includes identities of the apps, metadata (such as description, rating, and icon), and an access mechanism (such as a download link) for each of the selected apps. At 828, control sends a response and control ends.

In FIG. 9B, alternative control for preparing and sending a recommendation response based on user data is presented. Control begins at 904, where control updates a user record based on the installed apps specified by the recommendation request. At 908, control determines whether any previously installed apps are now missing. If so, control transfers to 912; otherwise, control transfers to 916. At 912, control notes the previously installed apps as being uninstalled for the user device. Control continues at 916.

At 916, control identifies a set of available actions from installed apps similarly to 804 of FIG. 9A. At 920, control selects a set of unavailable actions similarly to 808 of FIG. 9A. At 924, control determines a consideration set of apps that offer one or more of the unavailable actions, similarly to 812 of FIG. 9A. At both 812 and 924 of FIGS. 9A and 9B, respectively, control may remove apps from the consideration set that are already installed on the device.

At 928, control selectively removes apps from the consideration set when those apps have been uninstalled. In various implementations, removal of an app may be skipped in response to the uninstalled app having been supplemented with additional features since the time of the uninstall.

At 932, control scores each app in the consideration set. Scoring the apps may be based on user data, such as usage data for specific actions. For example, apps that offer an action that is frequently used by the user may have their score increased. At 936, control selects the highest scored apps in the consideration set. At 940, control prepares a response with information for the selected apps. At 944, control sends the prepared recommendation response and control ends.

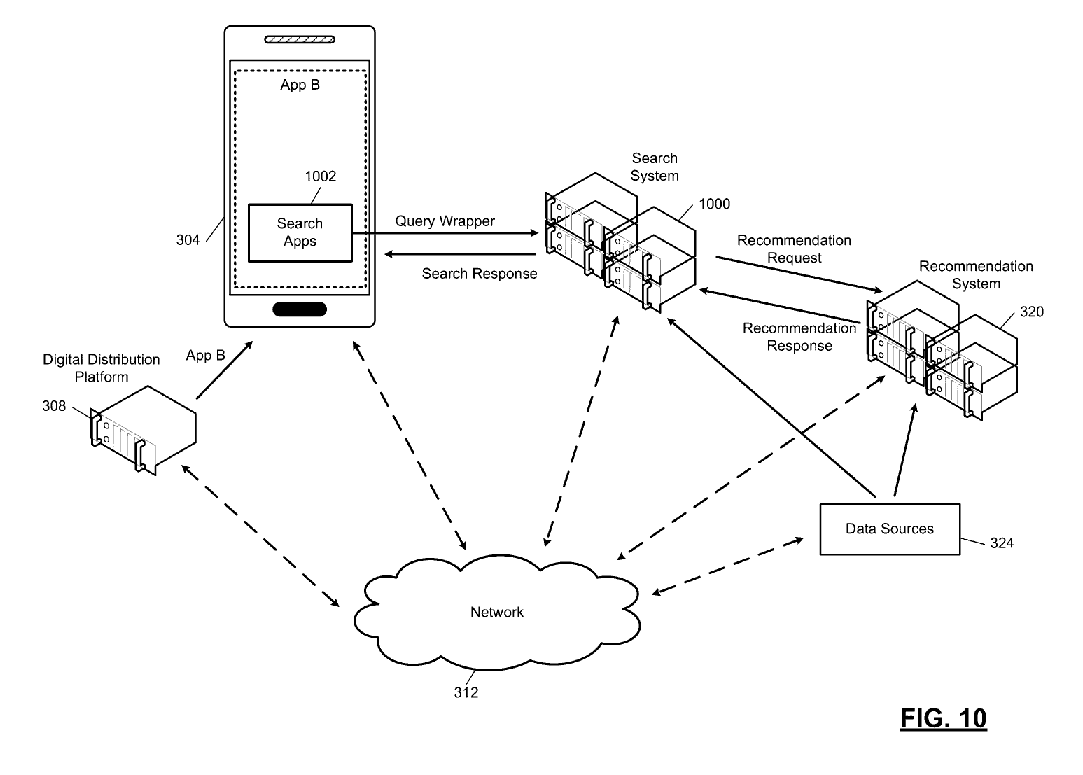

In FIG. 10, the recommendation system 320 is integrated with a search system 1000. An application, such as “App B,” is downloaded to the user device 304 from the digital distribution platform 308. App B has a user interface element 1002 to search for apps from the search system 1000. For example only, a textbox (not shown) may allow a user of App B to enter a textual query, and the user interface element 1002 sends the textual query to the search system 1000 in a query wrapper.

As shown in FIG. 10, the search system 1000 then sends a recommendation request to the recommendation system 320 and receives back a recommendation response. The search system 1000 may include data stores that are populated from similar or identical ones of the data sources 324.

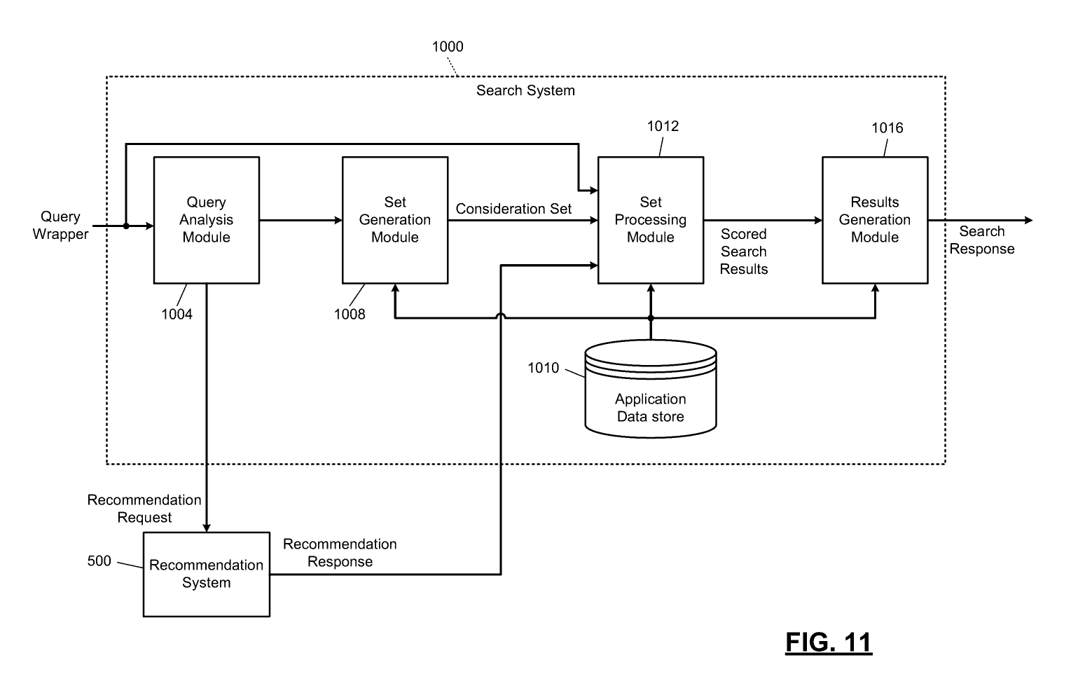

In FIG. 11, an example implementation of the application search module 700 includes a query analysis module 1004 that receives the query wrapper. The query analysis module 1004 analyzes the text query from the query wrapper. For example, the query analysis module 1004 may tokenize the query text, filter the query text, perform word stemming, synonymization, and stop word removal. The query analysis module 1004 may also analyze additional data stored within the query wrapper. Query tokens are provided by the query analysis module 1004 to a set generation module 1008.

The query analysis module 1004 may also send a recommendation request to the recommendation system 500. The set generation module 1008 identifies a consideration set of application records based on the query tokens. Some or all of the contents of the records of the application data store 1010 may be indexed in inverted indices. In some implementations, the set generation module 1008 uses the APACHE LUCENE software library by the Apache Software Foundation to identify records from the inverted indices.

The set generation module 1008 may search the inverted indices to identify records containing one or more of the query tokens. As the set generation module 1008 identifies matching records, the set generation module 1008 can include the unique ID of each identified record in the consideration set. Further, in some implementations, the set generation module 1008 may determine an initial score of the record with respect to the search query. The initial score may indicate how well the contents of the record matched the query tokens. For example, the initial score may be a function of the term frequency-inverse document frequency (TF-IDF) values of the respective query terms.

A set processing module 1012 receives the unique IDs from the set generation module 1008 and also receives IDs of recommended apps from the recommendation system 500. In other words, the recommended apps may simply be included as part of the consideration set. In other implementations, the recommended apps may retain a special status, such that some number of the recommended apps may be included in search results, regardless of the relative scores of the recommended apps.

The recommendation request sent to the recommendation system 500 may indicate what sort of apps are being searched for, which may alter the set of recommended apps. Alternatively, the recommendation request may simply identify a list of installed apps on the user device, and the recommendation response may then be generated independent of the app search being requested by the user. In this way, valuable recommendations can be made even when the user was searching in another area.

The set processing module 1012 determines a result score for some or all of the IDs. A result score indicates the relevance of an app, given the query tokens and context parameters, with a higher score indicating a greater perceived relevance. For example, other items in the query wrapper may act as context parameters. Geolocation data may limit the score (or simply remove altogether) of apps that are not pertinent to the location of the user device. A blacklist in the query wrapper may cause the set processing module 1012 to remove apps from the consideration set that match the criteria in the blacklist, or to set their score to zero.

The set processing module 1012 may generate a result score based on one or more scoring features, such as record scoring features, query scoring features, and record-query scoring features. Example record scoring features may be based on measurements associated with the record, such as how often the record is retrieved during searches and how often links generated based on the record are selected by a user. Query scoring features may include, but are not limited to, the number of words in the search query, the popularity of the search query, and the expected frequency of the words in the search query. Record-query scoring features may include parameters that indicate how well the terms of the search query match the terms of the record indicated by the corresponding ID.

The set processing module 1012 may include one or more machine learned models (such as a supervised learning model) configured to receive one or more scoring features. The one or more machine learned models may generate result scores based on at least one of the function ID scoring features, the record scoring features, the query scoring features, and the record-query scoring features.

For example, the set processing module 1012 may pair the search query with each ID and calculate a vector of features for each {query, ID} pair. The vector of features may include one or more record scoring features, one or more query scoring features, and one or more record-query scoring features. In some implementations, the set processing module 1012 normalizes the scoring features in the feature vector. The set processing module 1012 can set non-pertinent features to a null value or zero.

The set processing module 1012 may then input the feature vector for one of the application IDs into a machine-learned regression model to calculate a result score for the ID. In some examples, the machine-learned regression model may include a set of decision trees (such as gradient-boosted decision trees). Additionally or alternatively, the machine-learned regression model may include a logistic probability formula. In some implementations, the machine-learned task can be framed as a semi-supervised learning task, where a minority of the training data is labeled with human-curated scores and the rest of the data is used without human labels.

The machine-learned model outputs a result score of the ID. The set processing module 1012 can calculate result scores for each of the IDs that the set processing module 1012 receives. The set processing module 1012 associates the result scores with the respective IDs and outputs the most relevant scored IDs.

A results generation module 1016 builds a search response from the most relevant scored IDs, such as by combining textual and pictorial indications of the corresponding apps, as well as access mechanisms such as download links. In various implementations, the results generation module 1016 may select a predetermined number of recommended apps for inclusion in the search response. These recommended apps may be identified as recommended as opposed to being search-derived.

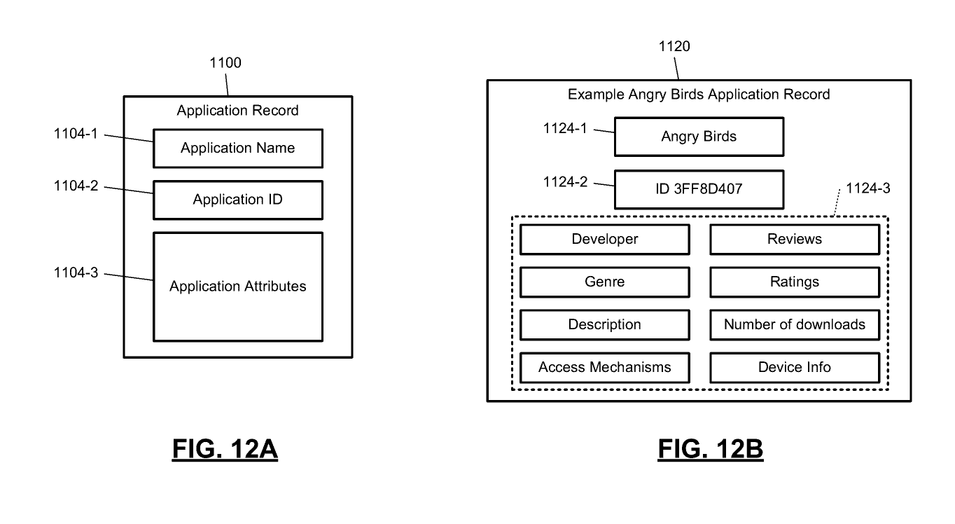

In FIG. 12A, an example format of an application record 1100 includes an application name 1104-1, an application identifier (ID) 1104-2, and application attributes 1104-3. The application record 1100 generally represents data that can be stored in the application data store 1010 for a specific application. The application data store 1010 may include thousands or millions of records having the structure specified by the application record 1100. The application ID 1104-2 uniquely identifies an application in the application data store 1010. The application ID 1104-2 may be assigned by the search system 1000 and may therefore be independent of any ID assigned by, for example, a digital distribution platform.

A single value for the application ID 1104-2 may cover multiple application editions. As described above, the term “edition” may apply to multiple versions of a single app and also to versions of that app released for alternative operating systems. For example only, Angry Birds (as shown in FIG. 12B) may be available on ANDROID and IOS operating system platforms and, for each platform, may have a series of versions as bug fixes are released and as the application is updated to take advantage of, and to adapt to, newer versions of operating system.

In FIG. 12B, an example application record 1120 includes a name 1124-1 of “Angry Birds” and a unique ID 1124-2 expressed in hexadecimal as 0x3FF8D407. Attributes 1124-3 for the ANGRY BIRDS app may include a name of the developer of Angry Birds (Rovio Entertainment Ltd.), text reviews of Angry Birds, a genre indicator for Angry Birds (such as “Games,” or sub-genre “Physics-Based Games”), ratings (such as star ratings) for Angry Birds, a textual description (which may be provided by the developer), a number of downloads (which may be restricted to the most recent edition or could be for all editions), access mechanisms (how to open Angry Birds when already installed or how to install Angry Birds when not yet installed), and device info (for example, minimum requirements of operating system, hardware, and resolution for best operation).

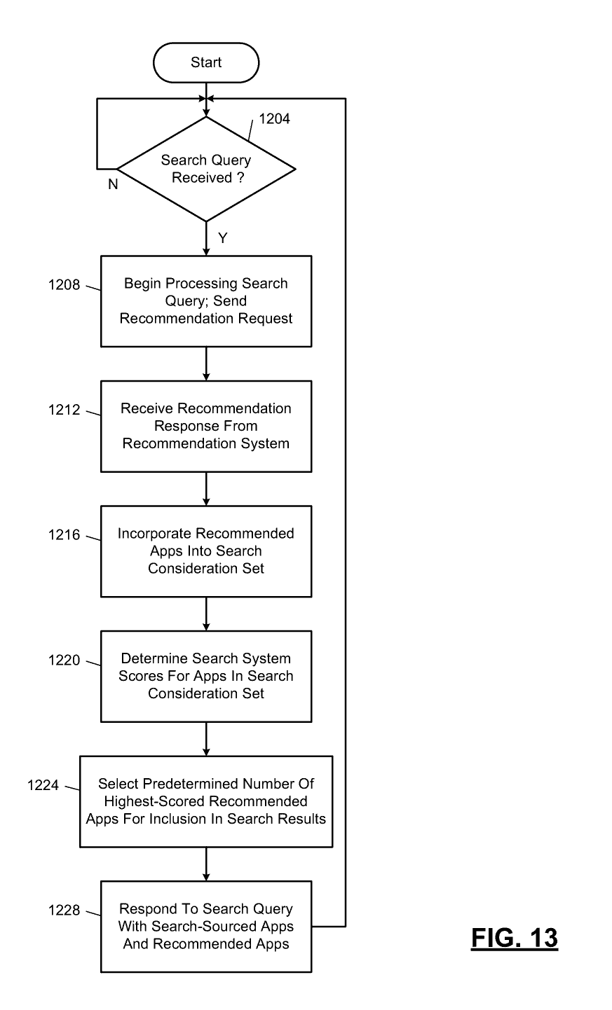

In FIG. 13, interaction between a search system and a recommendation system is shown. Control begins at 1204, where if a search query is received, control transfers to 1208; otherwise, control remains at 1204. At 1208, control begins processing the search query and sends a recommendation request to the recommendation system. At 1212, control receives a response from the recommendation system and at 1216, control incorporates the recommended apps from the recommendation response into the search consideration set.

At 1220, control determines search system scores for apps in the search consideration set. At 1224, control selects a predetermined number of the highest scoring recommended apps for inclusion in the search results. At 1228, control responds to the search query. Control then returns to 1204.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A OR B OR C), using a non-exclusive logical OR, and should not be construed to mean “at least one of A, at least one of B, and at least one of C.” It should be understood that one or more steps within a method may be executed in different order (or concurrently) without altering the principles of the present disclosure.

In this application, including the definitions below, the term ‘module’ or the term ‘controller’ may be replaced with the term ‘circuit.’ The term ‘module’ may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A system comprising:
a first data store configured to store a plurality of records, wherein each of the plurality of records:
corresponds to an application for a mobile device; and
includes metadata identifying actions available to a mobile device user through use of the application, wherein the identified actions are chosen from an ontology;
a query module configured to process an application recommendation request corresponding to a user device, wherein the application recommendation request includes data indicating a set of applications installed on the user device;
a set generation module configured to
identify, using the first data store, a set of available actions associated with the set of applications installed on the user device;
select a set of unavailable actions, wherein the set of unavailable actions is mutually exclusive with the set of available actions; and
determine a consideration set of applications from the first data store, wherein each application in the consideration set implements at least one of the set of unavailable actions;
a set processing module configured to select a chosen subset of applications from the consideration set of applications; and
a results generation module configured to respond to the application recommendation request with an application recommendation response, wherein the application recommendation response includes identifying data for each application in the chosen subset.

2. The system of claim 1 wherein:
the first data store, for each of the plurality of records, includes data for an access mechanism for the application; and
the application recommendation response includes the access mechanism for each application in the chosen subset.

3. The system of claim 2 wherein, for each of the plurality of records, the data for the access mechanism is a link to the application within a digital distribution platform.

4. The system of claim 1 wherein the set processing module is configured to:
determine a score for each of the applications in the consideration set; and
as the chosen subset, select a predetermined number of applications from the consideration set of applications that have highest scores.

5. The system of claim 4 wherein the score for an application is based on reviews of the application and download statistics for the application.

6. The system of claim 4 wherein the score for an application is inversely related to a total number of actions available to the user device through use of the application.

7. The system of claim 4 wherein the score for an application is directly related to a number of actions available to the user device through use of the application that are not within the set of available actions.

8. The system of claim 1 wherein the set processing module is configured to exclude, from the chosen subset, the set of applications installed on the user device.

9. The system of claim 1 wherein the set processing module is configured to exclude, from the chosen subset, applications that have been uninstalled from the user device.

10. The system of claim 1 wherein the set of available actions encompasses all actions within the ontology that are available to the user device through use of all of the set of applications installed on the user device.

11. The system of claim 1 wherein the set of applications installed on the user device encompasses all applications installed on the user device.

12. The system of claim 1 wherein the application recommendation request is triggered in response to, for a first action of the ontology that corresponded to no records in the first data store, a new record being added to the first data store and corresponding to the first action.

13. The system of claim 1 wherein:
the first data store, for each of the plurality of records, includes data regarding geographical relevance of the record; and
the application recommendation request is triggered in response to the user device moving from a first geographical area to a second geographical area.

14. The system of claim 1 further comprising a monitor module configured to generate the application recommendation request in response to the metadata for a first record of the plurality of records being updated to add an additional action when the application corresponding to the first record had been uninstalled from the user device.

15. The system of claim 1 further comprising a monitor module configured to generate the application recommendation request in response to the metadata for a first record of the plurality of records being updated to add an additional action when both (i) the application corresponding to the first record had been uninstalled from the user device and (ii) the additional action is outside the set of available actions.

16. The system of claim 1 wherein, for a first record of the first data store corresponding to an application from the set of applications installed on the user device, the application recommendation request is triggered in response to the metadata being updated to add an additional action.

17. The system of claim 1 wherein:
a first record of the first data store corresponds to multiple versions of a first application; and
the system includes a monitor module configured to generate the application recommendation request for the user device in response to a new version of the first application being added to the first record when both (i) the metadata for the new version includes an action from the ontology that is not included in previous versions of the first application and (ii) one of the previous versions of the first application is installed on the user device.

18. The system of claim 17 wherein the monitor module delays the application recommendation request until the user device has failed to install the new version of the first application for more than a predetermined period of time.

19. The system of claim 1 wherein:
a first record of the first data store corresponds to a first version of a first application; and
the system includes a monitor module configured to generate the application recommendation request for the user device in response to a second version of the first application being added to the first data store as a second record when both (i) the metadata for the second version includes an action from the ontology that is not included in the first version of the first application and (ii) the first version of the first application is installed on the user device.

20. The system of claim 1 wherein:
the ontology is grouped into a hierarchical tree in which each of the actions is a leaf node; and
the set generation module is configured to
identify parent nodes connected to multiple actions in the set of available actions; and
select remaining actions of the identified parent nodes as the set of unavailable actions.

21. The system of claim 1 wherein:
the ontology is grouped into a hierarchical tree in which each of the actions is a leaf node; and
the set processing module is configured to
assign a score to each of the consideration set of applications;
identify parent nodes connected to multiple actions in the set of available actions;
increase the score for applications that implement remaining actions of the identified parent nodes; and
select as the chosen subset the applications from the consideration set having highest scores.

22. The system of claim 1 further comprising a second data store configured to store a plurality of records, wherein each of the plurality of records:
corresponds to a user device; and
stores data identifying applications that have been uninstalled from the user device.

23. The system of claim 1 further comprising a second data store configured to store a plurality of user records, wherein:
each of the plurality of user records (i) corresponds to a user device and (ii) stores data identifying applications that have been identified as undesired by a user of the corresponding user device; and
the set processing module is configured to exclude applications from the chosen subset according to the second data store.

24. The system of claim 1 further comprising a second data store configured to store a plurality of user records, wherein:
each of the plurality of user records (i) corresponds to a user device and (ii) stores data identifying actions that have been identified as undesired by a user of the corresponding user device; and
the set generation module is configured to remove actions from the set of unavailable actions according to the second data store.

25. The system of claim 1 wherein the set generation module is configured to selectively include, in the consideration set of applications, a first application that duplicates actions from the set of available actions.

26. The system of claim 25 wherein:
the first application makes a first action of the ontology available to the user device; and
the set generation module is configured to include, in the consideration set of applications, the first application in response to usage data of the user device indicating a high usage of the first action.

27. The system of claim 26 wherein:
the set generation module is configured to determine that the usage of the first action is high in response to the usage of the first action exceeding a predetermined threshold; and
the predetermined threshold is based on an average usage of the set of available actions.

28. The system of claim 1 wherein the application recommendation request is received directly from the user device.

29. The system of claim 1 wherein the application recommendation request is received from a search platform in response to the search platform receiving an application search request from the user device.

30. The system of claim 29 wherein the application recommendation request includes data indicating that recommendations should be targeted to a scope of the application search request.

31. The system of claim 29 wherein the application recommendation response is independent of a scope of the application search request.

32. The system of claim 1 wherein:
each of the plurality of records includes additional metadata describing the corresponding application; and
the additional metadata includes a genre of the corresponding application.

33. The system of claim 32 wherein the additional metadata includes
(i) user-provided review data for the corresponding application and
(ii) download statistics for the corresponding application.

34. A method comprising:
storing a plurality of records into a first data store, wherein each of the plurality of records:
corresponds to an application for a mobile device; and
includes metadata identifying actions available to a mobile device user through use of the application, wherein the identified actions are chosen from an ontology;
processing an application recommendation request corresponding to a user device, wherein the application recommendation request includes data indicating a set of applications installed on the user device;
identifying, using the first data store, a set of available actions associated with the set of applications installed on the user device;
selecting a set of unavailable actions, wherein the set of unavailable actions is mutually exclusive with the set of available actions;
determining a consideration set of applications from the first data store, wherein each application in the consideration set implements at least one of the set of unavailable actions;
selecting a chosen subset of applications from the consideration set of applications; and
responding to the application recommendation request with an application recommendation response, wherein the application recommendation response includes identifying data for each application in the chosen subset.

35. A non-transitory computer-readable medium storing processor-executable instructions, the instructions comprising:
storing a plurality of records into a first data store, wherein each of the plurality of records:
corresponds to an application for a mobile device; and
includes metadata identifying actions available to a mobile device user through use of the application, wherein the identified actions are chosen from an ontology;
processing an application recommendation request corresponding to a user device, wherein the application recommendation request includes data indicating a set of applications installed on the user device;
identifying, using the first data store, a set of available actions associated with the set of applications installed on the user device;
selecting a set of unavailable actions, wherein the set of unavailable actions is mutually exclusive with the set of available actions;
determining a consideration set of applications from the first data store, wherein each application in the consideration set implements at least one of the set of unavailable actions;
selecting a chosen subset of applications from the consideration set of applications; and
responding to the application recommendation request with an application recommendation response, wherein the application recommendation response includes identifying data for each application in the chosen subset.
